(19) United States
(12) Patent Application Publication
(10) Pub. No.: US 2026/0001799 A1
(43) Pub. Date: Jan. 1, 2026

(54) MODULAR WATER FILTER SYSTEM

(71) Applicant: PFAS Guard LLC, Cary, NC (US)

(72) Inventors: Joseph Pearce, Raleigh, NC (US); Lauren Ashley Raup-Plummer, Raleigh, NC (US)

(21) Appl. No.: 19/180,830

(22) Filed: Apr. 16, 2025

Related U.S. Application Data
(60) Provisional application No. 63/635,214, filed on Apr. 17, 2024.

(51) Int. Cl. C02F 9/00; C02F 1/00; C02F 1/42; C02F 101/36

(52) U.S. Cl. CPC C02F 9/00; C02F 1/004; C02F 1/42; C02F 2101/36; C02F 2201/005; C02F 2201/007; C02F 2201/008; C02F 2209/03; C02F 2301/08

(57) ABSTRACT

A modular water filter system has an enclosure defining an enclosed space. The enclosure includes a base, a plurality of walls, and a roof surrounding the enclosed space. A water filter system is positioned within the enclosed space. The water filter system includes an inlet configured to receive raw water. A bag filter is coupled to the inlet. A first hose has a first end coupled to the filter and a second end coupled to a first Per- and Polyfluoroalkyl Substances (PFAS) or other treatment vessel. A second hose has a first end coupled to the first treatment vessel and a second end coupled to a second treatment vessel. A third hose has a first end coupled to the second treatment vessel and a second end coupled to a resin trap. An outlet is coupled to the resin trap and is configured to discharge filtered water.

### CROSS REFERENCE TO RELATED APPLICATIONS

This application is based upon and claims benefit of priority to U.S. Provisional Application No. 63/635,214, filed Apr. 17, 2024, the entirety of which is hereby incorporated by reference herein.

### FIELD

Disclosed herein is a modular water filter system for filtering water.

### BACKGROUND

FIG. 1 shows an example conventional water filter system 4 positioned within a building 2. As shown in FIG. 1, a conventional water filter system 4 typically includes a plurality of valves, such as a valve tree 6, to control the direction and flow of water through the system and allow for operation of the filters in series, parallel, or reversed series. These valve trees 6 are costly and increase the footprint of the filter system building 2 and are subject to increase the system operating pressure loss, and increase the risk of improper system lead lag operation. The valve trees 6 also make assembly or disassembly of the filter canisters to or from the system challenging, complicated, and time consuming. Therefore, the media in the canisters is typically replaced on site which increases the risk of contamination. These features require the building 2 to be sized to allow a person or people to be within the enclosed space of the building to allow for testing and maintenance thereby requiring the building to be rather large, often so large that a building permit is required for construction. Also, these buildings 2 typically comprise wood supports and asphalt shingles, which are subject to rot from humidity and cannot be easily assembled or disassembled.

There is clearly a need for a modular water filter system that addresses one or more of these issues. For example, there is a need for a modular water filter system that does not include a valve tree and has an enclosure that is resilient, does not require a building permit, allows rapid deployment and replacement, and/or may be refurbished offsite.

### SUMMARY

The disclosure concerns a water filter system. An example water filter system comprises an inlet configured to receive raw water. A bag filter is coupled to the inlet. A first hose has a first end coupled to the filter and a second end coupled to a first Per- and Polyfluoroalkyl Substances (PFAS) or other pollutant treatment vessel (referred to herein as “treatment vessel”). A second hose has a first end coupled to the first treatment vessel and a second end coupled to a second treatment vessel. The system comprises a resin trap. A third hose has a first end coupled to the second treatment vessel and a second end coupled to a resin trap. An outlet is coupled to the resin trap and is configured to discharge filtered water.

In one aspect, the second end of the first hose and the first end of the second hose are coupled to the first treatment vessel via flanged elbows, and the second end of the second hose and the first end of the third hose are coupled to the second treatment vessel via flanged elbows.

In one aspect, the second end of the first hose and the first end of the second hose are coupled to the first treatment vessel via valves, and the second end of the second hose and the first end of the third hose are coupled to the second treatment vessel via valves.

In one aspect, the first end of the first hose is connected to the bag filter via a valve.

In one aspect, the second end of the third hose is connected to the resin trap via a valve.

In one aspect, the bag filter is a vertical bag filter.

In one aspect, the first treatment vessel and the second treatment vessel each include an air release valve.

In one aspect, the system further comprises a heater.

In one aspect, the system further comprises a dehumidifier.

In one aspect, the system further comprises at least one sampling location.

In one aspect, the first treatment vessel and the second treatment vessel are lead-lag vessels.

In one aspect, the system further comprises pressure reading locations.

In one aspect, the water filter system footprint and enclosure is less than 10 feet by 12 feet.

In one aspect, the first treatment vessel and the second treatment vessel are configured to allow for three possible methods of media replacement, including: for off-site media replacement after water only is drained from the vessel, or on-site media replacement using a media slurry, or on-site media replacement using a vacuum system.

In one aspect, the first treatment vessel and the second treatment vessel have a media height of at least 3 feet.

In one aspect, the water filter system does not comprise a plurality of valves configured to control the direction of water flow through the water filter system.

In one aspect, the water filter system does not comprise a valve tree.

The disclosure also concerns a modular water filter system. An example modular water filter system comprises an enclosure defining an enclosed space. The enclosure has a base, a plurality of walls, and a roof surrounding the enclosed space. At least one wall of the plurality of walls includes at least one removable panel. Optionally, at least one wall of the plurality of walls can comprise a plurality of removable panels. In further optional aspects, at least one wall of the plurality of walls may not include any removable panels. An example water filter system as described herein is positioned within the enclosed space.

In one aspect, the enclosure comprises at least one of aluminum and insulating material.

In one aspect, at least one removable panel comprises at least one swing door positioned and sized to allow access for sampling and maintenance.

In one aspect, the at least one removable panel comprises a first removable panel positioned and sized to allow removal and installation of the first treatment vessel and a second removable panel positioned and sized to allow removal and installation of the second treatment vessel.

In one aspect, the enclosure has a first dimension (e.g., a length) of less than 12 feet, a second dimension (e.g., a height) of less than 8 feet, and/or a third dimension (e.g., a width) of less than 10 feet. Thus, in use, the enclosure occupies a volume of less than 960 square feet.

In one aspect, the enclosure comprises self-opening drains to handle potential flows from water systems leaks or pipe breaks.

In one aspect, the enclosure has a size that does not require a building permit.

In one aspect, the enclosure is a public utility enclosure.

In one aspect, the first treatment vessel and the second treatment vessel are installed on platforms configured to receive forks of a forklift.

### DESCRIPTION OF THE DRAWINGS

FIG. 1 shows an example water filter system and building according to the prior art.

FIG. 2 shows a front perspective view of an example water filter system according to the disclosure.

FIG. 3 shows a rear perspective view of the example water filter system shown in FIG. 2.

FIG. 4 shows a front perspective view of an example modular water filter system according to the disclosure.

FIG. 5 shows an end elevation view of the example modular filter system shown in FIG. 4.

### DETAILED DESCRIPTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout. It is to be understood that this invention is not limited to the particular methodology and protocols described, as such may vary. It is also to be understood that the terminology used herein is for the purpose of describing particular embodiments only, and is not intended to limit the scope of the present invention.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

As used herein the singular forms “a,” “an,” and “the” include plural referents unless the context clearly dictates otherwise. For example, unless the context dictates otherwise, use of the term “a valve” can represent disclosure of embodiments in which only a single such valve is provided, as well as disclosure of embodiments in which a plurality of such valves are provided, and so forth.

All technical and scientific terms used herein have the same meaning as commonly understood to one of ordinary skill in the art to which this invention belongs unless clearly indicated otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. Optionally, in some aspects, when values are approximated by use of the antecedent “about,” it is contemplated that values within up to 15%, up to 10%, up to 5%, or up to 1% (above or below) of the particularly stated value can be included within the scope of those aspects. Similarly, in some optional aspects, when values are approximated by use of the terms “approximately,” “substantially,” or “generally,” it is contemplated that values within up to 15%, up to 10%, up to 5%, or up to 1% (above or below) of the particular value can be included within the scope of those aspects. When used with respect to an identified property or circumstance, “substantially” or “generally” can refer to a degree of deviation that is sufficiently small so as to not measurably detract from the identified property or circumstance, and the exact degree of deviation allowable may in some cases depend on the specific context.

As used herein, the terms “optional” or “optionally” mean that the subsequently described event or circumstance may or may not occur, and that the description includes instances where said event or circumstance occurs and instances where it does not.

The following description supplies specific details in order to provide a thorough understanding. Nevertheless, the skilled artisan would understand that the system and associated methods of using the system can be implemented and used without employing these specific details. Indeed, the system and associated methods can be placed into practice by modifying the illustrated apparatus and associated methods and can be used in conjunction with any other apparatus and techniques conventionally used in the industry.

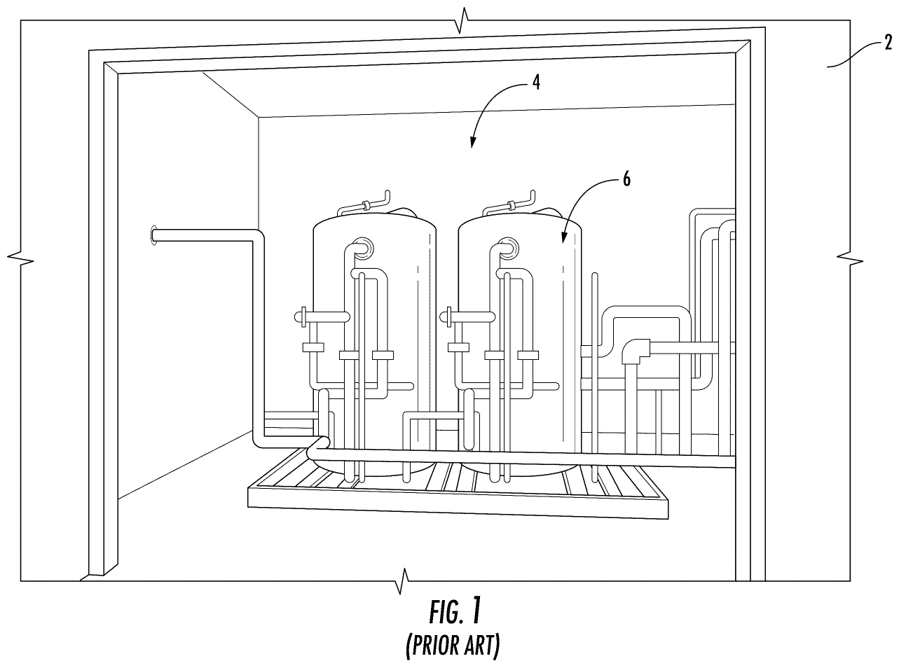

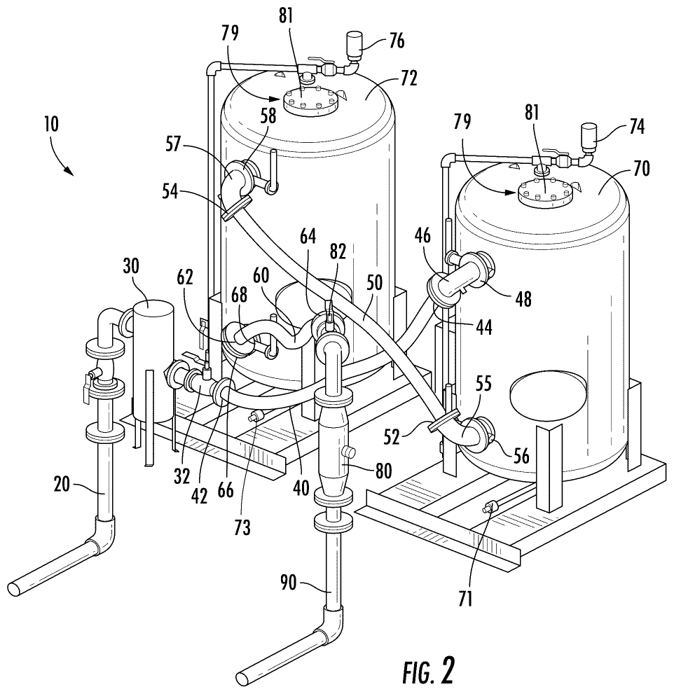

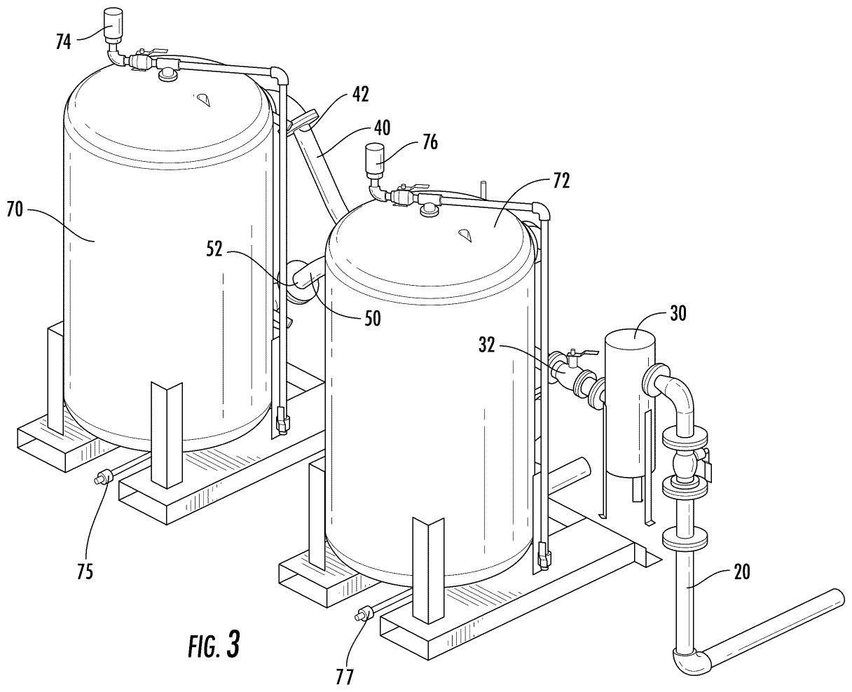

FIGS. 2 and 3 show an example water filter system 10 for filtering water. As shown in the figures, unlike many conventional water filter systems, like the example system shown in FIG. 1, the water filter system 10 does not comprise a plurality of valves configured to control the direction of water flow through the water filter system. More specifically, the water filter system 10 does not comprise a valve tree. Instead, the water filter system 10 uses a resourceful and effective design involving hoses 40, 50, 60 that allow for operation of the filtering Per- and Polyfluoroalkyl Substances (PFAS) or other pollutant treatment vessels in series or reversed series and may have a footprint (i.e. horizontal dimensions) that is less than 10 feet by 12 feet. Advantageously, the hoses 40, 50, 60 may provide flexibility, making assembly and disassembly easier and more efficient than valve trees including rigid pipe. Other pollutants may include, for example, radium, uranium, nitrate, etc. Optionally, the filter system and enclosure or enclosure footprint (i.e. horizontal dimensions) is less than 10 feet by 12 feet. The water filter system 10 may also be designed for up to 200 gallons per minute. The example water filter system 10 may include a first, second and third hose 40, 50, 60 to connect a first treatment vessel 70 and a second treatment vessel 72 in series or reversed series. Each hose 40, 50, 60 may be a National Sanitation Foundation (NSF) approved hose. Optionally, each hose 40, 50, 60 may be an NSF approved hose at the time the present application is filed. The first treatment vessel 70 and the second treatment vessel 72 may be lead-lag vessels. Optionally, the first treatment vessel 70 and the second treatment vessel 72 may have a media height of at least 3 feet (e.g., a height ranging from 3 feet to 8 feet). Optionally, the first treatment vessel 70 and the second treatment vessel 72 each include an air release valve 74, 76. Optionally, each treatment vessel 70 may comprise NSF media (optionally, NSF approved media at the time of filing).

As shown in FIGS. 2 and 3, the example water filter system 10 comprises an inlet 20 configured to receive raw water. A filter 30 (e.g., a bag filter) may be coupled to the inlet 20. Optionally, the filter 30 may be a vertical bag filter. The first hose 40 connects the inlet 20 and filter (e.g., bag filter) 30 to the first treatment vessel 70. A first end 42 of the first hose 40 is coupled to the filter (e.g., bag filter) 30. Optionally, the first end 42 of the first hose 40 is connected to the filter (e.g., bag filter) 30 via a valve 32. A second end 44 of the first hose 40 is coupled to the first treatment vessel 70. The second hose 50 connects the first treatment vessel 70 and the second treatment vessel 72. A first end 52 of the second hose 50 is coupled to the first treatment vessel 70. Optionally, the second end 44 of the first hose 40 and the first end 52 of the second hose 50 are coupled to the first treatment vessel 70 via flanged elbows 46, 55. Optionally, the second end 44 of the first hose 40 and the first end 52 of the second hose 50 are coupled to the first treatment vessel 70 via valves 48, 56. A second end 54 of the second hose 50 is coupled to the second treatment vessel 72. A third hose 60 connects the second treatment vessel 72 to a resin trap 80 and outlet 90. A first end 62 of the third hose 60 is coupled to the second treatment vessel 72. Optionally, the second end 54 of the second hose 50 and the first end 62 of the third hose 60 are coupled to the second treatment vessel 72 via flanged elbows 57, 66. Optionally, the second end 54 of the second hose 50 and the first end 64 of the third hose 60 are coupled to the second treatment vessel 72 via valves 58, 68. A second end 54 of the third hose 60 is coupled to the resin trap 80. Optionally, the second end 64 of the third hose 60 is connected to the resin trap 80 via a valve 82. The resin trap 80 is configured to capture any resin in the filtered water. The outlet 90 is coupled to the resin trap 80 and is configured to discharge filtered water.

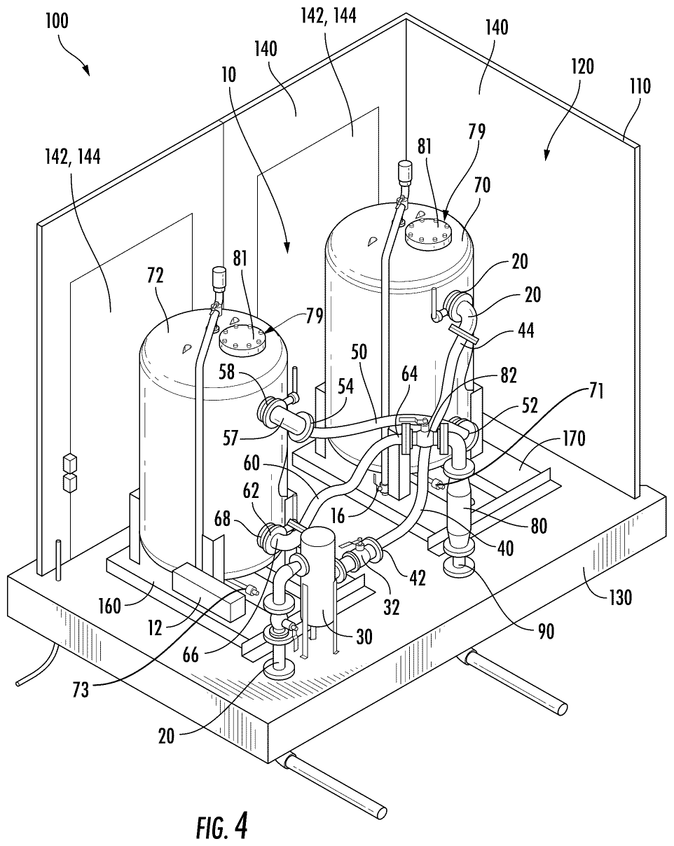

Advantageously, the system 10 may include components that allow for media replacement on-site and/or off-site. As shown in FIGS. 2 and 4, the system 10 may comprise at least one drainage pipe 71, 73 coupled to a vessel 70 or 72 configured to drain the media and liquid (e.g. water) from the vessel 70 or 72. The system 10 may comprise a first drainage pipe 71 coupled to the first treatment vessel 70 and a second drainage pipe 73 coupled to the second treatment vessel 72. The first drainage pipe 71 and the second drainage pipe 73 may be configured to drain the media and liquid from within the respective vessel 70, 72. The first drainage pipe 71 and the second drainage pipe 73 may allow media replacement on-site using a media slurry. As shown in FIG. 3, the system 10 may comprise at least one drainage pipe 75, 77 coupled to a vessel 70 or 72 configured to drain the liquid (e.g. water) only from the vessel 70 or 72. The system 10 may comprise a third drainage pipe 75 coupled to the first treatment vessel 70 and a fourth drainage pipe 77 coupled to the third treatment vessel 72. The third drainage pipe 75 and the fourth drainage pipe 77 may be configured to drain liquid only from the respective vessel 70, 72. The third drainage pipe 75 and the fourth drainage pipe 77 may each comprise a screen to filter and drain the liquid from the media. The third drainage pipe 75 and the fourth drainage pipe 77 may drain the liquid (e.g. water) from the vessels 70, 72 for off-site media replacement. Optionally, as shown in FIGS. 2, 4, and 5, each vessel 70, 72 may comprise an opening 79 which may be covered by a removable cap 81. Each opening may be configured to allow for on-site media replacement using a vacuum system.

The flanged elbow and/or valve connection of the treatment vessels and the hoses allow the treatment vessels to be quickly and easily assembled to or disassembled from the other components of the water filter system including, in this example, at least the hoses, filter (e.g., bag filter), resin trap, inlet, and outlet. The quick and easy assembly and disassembly of the treatment vessels to the hoses may allow the first treatment vessel 70 and the second treatment vessel 72 to be configured for off-site media replacement.

The water filter system 10 may further comprise a heater 12 and/or a dehumidifier 14. The water filter system 10 may also comprise at least one sampling location 16. For example, each vessel 70, 72 may comprise a port for obtaining a sample of water. The water filter system 10 may comprise at least one pressure reading location. For example, each vessel 70, 72 may comprise a meter indicating pressure within the vessel 70, 72.

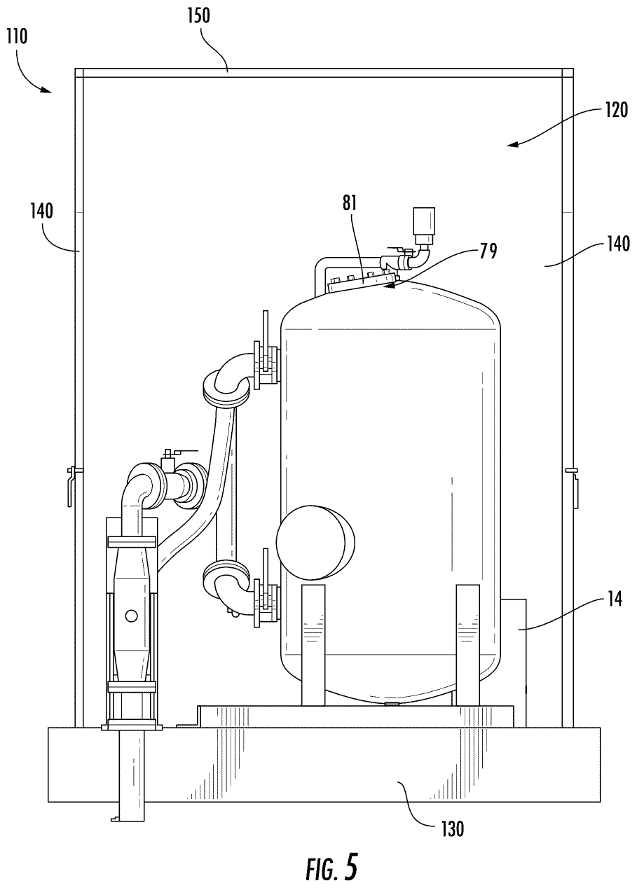

FIGS. 4 and 5 show an example modular water filter system 100. The modular water filter system 100 comprises an enclosure 110 defining an enclosed space 120. The enclosure 110 may comprise aluminum and/or insulating material (optionally, foam) to prevent rotting and rust. Optionally, the enclosure 110 does not comprise wood and/or shingles. The enclosure 110 has a base 130, a plurality of walls 140, and a roof 150 surrounding the enclosed space 120. The enclosure 110 may allow for quick and easy assembly and disassembly. An example water filter system 10 as described herein is positioned within the enclosed space 120. The enclosure 110 may be sized to fit a water filter system 10. Optionally, the enclosure 110 may be sized to fit a water filter system 10 without additional space for a person or people to be within the enclosure 110. The enclosure 110 may be less than 12 feet by 8 feet by 10 feet. The enclosure 110 may be a size that is smaller than the building size for which a building permit is required in certain jurisdictions based on state or local building codes. For example, each dimension (e.g., length, width, and height) of the enclosure 110 may be equal or less than 12 feet. The enclosure 110 may be a public utility enclosure.

At least one wall of the plurality of walls 140 includes at least one removable panel 142. The at least one removable panel 142 may comprise at least one swing door positioned and sized to allow access for sampling and maintenance. The at least one removable panel 142 may comprise a first removable panel 144 positioned and sized to allow removal and installation of the first treatment vessel 70 and a second removable panel 146 positioned and sized to allow removal and installation of the second treatment vessel 72. The removable panels 144, 146 may allow the vessels 70, 72 to be disassembled from the hoses 40, 50, 60 and removed through the removable panels 144, 146 to allow for media replacement offsite, maintenance offsite, or replacement of the vessels 70, 72. The first treatment vessel 70 and the second treatment vessel 72 may be installed on platforms 160, 170 configured to receive forks of a forklift to allow for movement and transportation of the vessels 70, 72.

Assembling the modular water filter system may comprise constructing the enclosure on-site. Constructing the enclosure may comprise installing the base which may include pouring a concrete pad on-site or installing a precast concrete pad. The plurality of walls may be attached to the base and each other. The roof may be installed by attaching the roof to the plurality of walls. The simplicity of the enclosure may allow for a quick and easy assembly. The enclosure may be installed/assembled in less than 3 hours. A water filter system may be positioned and assembled within the enclosure. Assembling the water filter system may comprise positioning each vessel in the enclosure. The resin trap may be positioned and assembled in the enclosure. The hoses may be cut to size on-site. Each hose may be coupled to a respective flange which is then bolted to a vessel, and each hose may comprise flexible material that avoids the need for exact precision during alignment and assembly. The simplicity and flexibility of the water filter system may allow for a quick and easy assembly of the water filter system. The water filter system may be installed/assembled in less than 10 hours.

Although the foregoing invention has been described in some detail by way of illustration and example for purposes of clarity of understanding, certain changes and modifications may be practiced within the scope of the appended claims.

### Exemplary Aspects

In view of the described products, systems, and methods and variations thereof, herein below are described certain more particularly described aspects of the invention. These particularly recited aspects should not however be interpreted to have any limiting effect on any different claims containing different or more general teachings described herein, or that the “particular” aspects are somehow limited in some way other than the inherent meanings of the language literally used therein.
Aspect 1: A water filter system comprising:
an inlet configured to receive raw water;
a bag filter coupled to the inlet;
a first hose having a first end coupled to the filter and a second end coupled to a first treatment vessel;
a second hose having a first end coupled to the first treatment vessel and a second end coupled to a second treatment vessel;
a resin trap;
a third hose having a first end coupled to the second treatment vessel and a second end coupled to the resin trap; and
an outlet coupled to the resin trap and configured to discharge filtered water.
Aspect 2: The water filter system according to aspect 1, wherein the second end of the first hose and the first end of the second hose are coupled to the first treatment vessel via flanged elbows, and the second end of the second hose and the first end of the third hose are coupled to the second treatment vessel via flanged elbows.
Aspect 3: The water filter system according to any of the preceding aspects, wherein the second end of the first hose and the first end of the second hose are coupled to the first treatment vessel via valves, and the second end of the second hose and the first end of the third hose are coupled to the second treatment vessel via valves.
Aspect 4: The water filter system according to any of the preceding aspects, wherein the first end of the first hose is connected to the bag filter via a valve.
Aspect 5: The water filter system according to any of the preceding aspects, wherein the second end of the third hose is connected to the resin trap via a valve.
Aspect 6: The water filter system according to any of the preceding aspects, wherein the bag filter is a vertical bag filter.
Aspect 7: The water filter system according to any of the preceding aspects, wherein the first treatment vessel and the second treatment vessel each include an air release valve.
Aspect 8: The water filter system according to any of the preceding aspects further comprising a heater.
Aspect 9: The water filter system according to any of the preceding aspects further comprising a dehumidifier.
Aspect 10: The water filter system according to any of the preceding aspects further comprising at least one sampling location.
Aspect 11: The water filter system according to any of the preceding aspects, wherein the first treatment vessel and the second treatment vessel are lead-lag vessels.
Aspect 12: The water filter system according to any of the preceding aspects further comprising pressure reading locations.
Aspect 13: The water filter system according to any of the preceding aspects, wherein the water filter system footprint is less than 10 feet by 12 feet.
Aspect 14: The water filter system according to any of the preceding aspects, wherein the first treatment vessel and the second treatment vessel are configured for off-site media replacement.
Aspect 15: The water filter system according to any of the preceding aspects, wherein the first treatment vessel and the second treatment vessel have a media height of at least 3 feet.
Aspect 16: The water filter system according to any of the preceding aspects, wherein the water filter system does not comprise a plurality of valves configured to control the direction of water flow through the water filter system.
Aspect 17: The water filter system according to any of the preceding aspects, wherein the water filter system does not comprise a valve tree.
Aspect 18: A modular water filter system comprising:
an enclosure defining an enclosed space, the enclosure having a base, a plurality of walls, and a roof surrounding the enclosed space, at least one wall of the plurality of walls including at least one removable panel; and
a water filter system according to any one of the preceding aspects positioned within the enclosed space.
Aspect 19: The modular water filter system according to aspect 18, wherein the enclosure comprises at least one of aluminum and insulating material.
Aspect 20: The modular water filter system according to aspect 18 or 19, wherein the at least one removable panel comprises at least one swing door positioned and sized to allow access for sampling and maintenance.
Aspect 21: The modular water filter system according to any of aspects 18-20, wherein the at least one removable panel comprises a first removable panel positioned and sized to allow removal and installation of the first treatment vessel and a second removable panel positioned and sized to allow removal and installation of the second treatment vessel.
Aspect 22: The modular water filter system according to any of aspects 18-21, wherein the enclosure is less than 12 feet by 8 feet by 10 feet.
Aspect 23: The modular water filter system according to any of aspects 18-22, wherein the enclosure is a size that does not require a building permit.
Aspect 24: The modular water filter system according to any of aspects 18-23, wherein the first treatment vessel and the second treatment vessel are installed on platforms configured to receive forks of a forklift.
Aspect 25: A method of assembling the modular water filter system according to any of aspects 18-24.

What is claimed is:

1. A water filter system comprising:
an inlet configured to receive raw water;
a bag filter coupled to the inlet;
a first hose having a first end coupled to the filter and a second end coupled to a first treatment vessel;
a second hose having a first end coupled to the first treatment vessel and a second end coupled to a second treatment vessel;
a resin trap;
a third hose having a first end coupled to the second treatment vessel and a second end coupled to the resin trap; and
an outlet coupled to the resin trap and configured to discharge filtered water.

2. The water filter system of claim 1, wherein the second end of the first hose and the first end of the second hose are coupled to the first treatment vessel via flanged elbows, and the second end of the second hose and the first end of the third hose are coupled to the second treatment vessel via flanged elbows.

3. The water filter system of claim 1, wherein the second end of the first hose and the first end of the second hose are coupled to the first treatment vessel via valves, and the second end of the second hose and the first end of the third hose are coupled to the second treatment vessel via valves.

4. The water filter system of claim 1, wherein the first end of the first hose is connected to the bag filter via a valve.

5. The water filter system of claim 1, wherein the second end of the third hose is connected to the resin trap via a valve.

6. The water filter system of claim 1 further comprising a heater and a dehumidifier.

7. The water filter system of claim 1 further comprising at least one of at least one pressure reading location and at least one sampling location.

8. The water filter system of claim 1, wherein the first treatment vessel and the second treatment vessel are lead-lag vessels.

9. The water filter system of claim 1, wherein the water filter system footprint is less than 10 feet by 12 feet.

10. The water filter system of claim 1, wherein the first treatment vessel and the second treatment vessel are configured for off-site media replacement.

11. The water filter system of claim 1, wherein the first treatment vessel and the second treatment vessel have a media height of at least 3 feet.

12. The water filter system of claim 1, wherein the water filter system does not comprise a plurality of valves configured to control the direction of water flow through the water filter system.

13. The water filter system of claim 1, wherein the water filter system does not comprise a valve tree.

14. A modular water filter system comprising:
an enclosure defining an enclosed space, the enclosure having a base, a plurality of walls, and a roof surrounding the enclosed space, at least one wall of the plurality of walls including at least one removable panel; and
a water filter system comprising:
an inlet configured to receive raw water,
a bag filter coupled to the inlet,
a first hose having a first end coupled to the filter and a second end coupled to a first Per- and Polyfluoroalkyl Substances (treatment) vessel,
a second hose having a first end coupled to the first treatment vessel and a second end coupled to a second treatment vessel,
a resin trap,
a third hose having a first end coupled to the second treatment vessel and a second end coupled to the resin trap, and
an outlet coupled to the resin trap and configured to discharge filtered water.

15. The modular water filter system of claim 14, wherein the enclosure comprises at least one of aluminum and insulating material.

16. The modular water filter system of claim 14, wherein the at least one removable panel comprises at least one swing door positioned and sized to allow access for sampling and maintenance.

17. The modular water filter system of claim 14, wherein the at least one removable panel comprises a first removable panel positioned and sized to allow removal and installation of the first treatment vessel and a second removable panel positioned and sized to allow removal and installation of the second treatment vessel.

18. The modular water filter system of claim 14, wherein the enclosure has a first dimension of less than 12 feet, a second dimension of less than 8 feet, and a third dimension of less than 10 feet.

19. The modular water filter system of claim 14, wherein the enclosure is a size that does not require a building permit.

20. The modular water filter system of claim 14, wherein the first treatment vessel and the second treatment vessel are installed on platforms configured to receive forks of a forklift.
